(19) United States
(12) Patent Application Publication
(10) Pub. No.: US 2022/0052961 A1
(43) Pub. Date: Feb. 17, 2022

(54) RESOURCE DISCOVERY IN A MULTI-EDGE COMPUTING NETWORK

(71) Applicant: Verizon Patent and Licensing Inc., Basking Ridge, VA (US)

(72) Inventors: Maqbool Chauhan, Keller, TX (US); Sudhakar Reddy Patil, Flower Mound, TX (US); Parry Cornell Booker, Arlington, TX (US); Matthew Nelson, Pleasanton, CA (US); Jerry Steben, Fort Worth, TX (US); David Taft, Keller, TX (US)

(21) Appl. No.: 16/990,588

(22) Filed: Aug. 11, 2020

(51) Int. Cl. H04L 12/911; H04L 29/12

(52) U.S. Cl. CPC H04L 47/82; H04L 61/3025; H04L 61/20

(57) ABSTRACT

Methods and systems are disclosed for discovering resources in a multi-access computing environment. The method may include receiving application parameters for an application to be serviced using multi-access edge computing (MEC) resources. The method may also include generating network address identifiers associated with the application based on the application parameters, and storing, in a memory, the network address identifiers associated with the application to be serviced using the MEC resources. The method may include deploying an instance of the application at a MEC cluster. The deployed instance of the application may be accessible by user equipment with one of the network address identifiers.

### BACKGROUND

Multi-access edge computing (MEC) (also known as mobile edge computing) allows for network capabilities that may have been previously implemented in a core network to be situated at the network edge. A MEC network may enable improved latency and help reduce traffic being sent to the core network. Additionally, other technologies, such as cloud computing, and software defined networking (SDN), are also being explored to provision services and applications to various end devices and end users.

### BRIEF DESCRIPTION OF THE DRAWINGS

FIG. 1 illustrates an exemplary environment in which systems and methods described herein may be implemented;

FIG. 2A is a diagram of exemplary network connections in a portion of the environment of FIG. 1;

FIG. 2B is an example of service operations that may be used in interactions between an application function and an application exposure function of FIG. 2A;

FIG. 3 illustrates exemplary components of a device that may correspond to one or more of the devices illustrated and described herein;

FIGS. 4A and 4B are signal flow diagrams of exemplary communications for configuring MEC resources to direct a client to the optimal MEC instance in a portion of the network of FIG. 2A;

FIG. 5A is an example of fields that may be included in the network repository function database of FIG. 2A;

FIG. 5B is an example of fields that may be included in the application policy of FIG. 4;

FIG. 6 is a flowchart illustrating an exemplary process for managing and selecting resources in a MEC network, according to implementations described herein;

FIG. 7 is a signal flow diagram of exemplary communications for assigning MEC resources; and

FIG. 8 is a flowchart illustrating an exemplary process for managing and selecting resources in a MEC network, according to implementations described herein

### DETAILED DESCRIPTION OF THE PREFERRED EMBODIMENTS

The following detailed description refers to the accompanying drawings. The same reference numbers in different drawings may identify the same or similar elements. Also, the following detailed description does not limit the invention.

A MEC cluster/network may enable computing loads to be transferred to a network's edge. Depending on the location of edge devices (e.g., edge servers) relative to the point of attachment (e.g., a wireless station for an end device), MEC clusters may provide services to MEC applications that can be utilized by MEC-enabled applications running on user equipment (UE) devices (e.g., an end devices). As the terms are used herein, a “MEC application” is an application that runs in a MEC cluster. The MEC application provides services to a “MEC-enabled application” that runs in a UE device (or a “MEC-enabled device”).

MEC clusters can provide MEC applications with compute, storage, and transport resources near a network edge and may be suitable for applications desiring low-latency, localized compute, and localized storage requirements. Generally, lower latencies are achieved when MEC resources are positioned with shorter physical distances to the network edge. Thus, service providers may establish MEC clusters in multiple, different geographic regions to provide services and guarantee certain quality-of-service (QoS) levels.

A MEC application may register with a service provider to make the application available for MEC services (e.g., available to an MEC-enabled application running on a UE device). For each application, the developer and/or customer may select an application policy that defines service parameters, such as achieving certain key performance indicators (KPIs) and/or service level agreements (SLAs) for MEC services. In some cases, a customer/developer may select different KPIs and SLAs for different geographic regions. For example, a customer may set a regional application policy that provides a premium level of service, with a latency/round-trip delay time (RTT) of less than 30 milliseconds (among other parameters), for users in New York City. In contrast, the customer's application policy may require a less-stringent latency/RTT of up to 75 milliseconds for users in the surrounding suburbs and other areas.

To ensure that a mobile application receives the services for users in different locations, application services (e.g., computation, storage, transport, etc. for the particular application) may be deployed in different MEC locations. There may be challenges for an application provider to determine which MEC clusters can satisfy the SLA requirements for a given end device at a given location. In this situation, a MEC orchestrator may use cellular network intelligence to derive the right control points to enable the network to select an appropriate MEC cluster for an end device in a given area.

When an application is deployed on a MEC platform, the corresponding MEC-enabled application on user equipment may not be aware of the MEC location and application instance it needs to access, particularly when the MEC application that the user equipment is trying to access is not in its presence area.

Systems and methods described herein may direct a UE device to a MEC instance among multiple MEC instances with different service levels for different geographic areas. A network device receives application parameters, for a designated coverage area, for an application to be serviced using MEC resources. The network device deploys an instance of the application at a MEC cluster. The network device may generate network address identifiers (e.g., domain names, fully-qualified domain names (FQDNs), or more simply “network addresses”) for sending to user equipment when the associated MEC-enabled application attaches to the network. The network device may update a MEC-domain name service (DNS) for the deployed instance of the application at the MEC cluster.

In one embodiment, MEC applications are registered with a network repository function (e.g., via an application function and/or network exposure function) with FQDNs. The FQDNs and/or other associated information may be passed to user equipment running the MEC-enabled application (e.g., during initial registration). This embodiment may facilitate the discovery of the appropriate MEC and MEC application that the user equipment is attempting to access (e.g., such as a MEC outside a presence area).

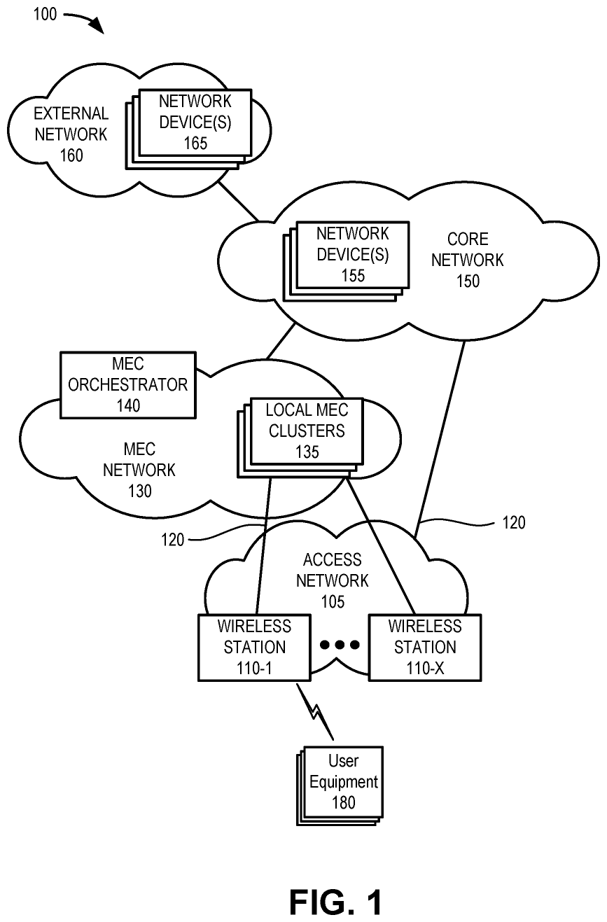

FIG. 1 illustrates an exemplary environment 100 in which systems and methods described herein may be implemented. As shown, environment 100 includes an access network 105, a MEC network 130, a core network 150, and an external network 160. Access network 105 may include wireless stations 110-1 through 110-X (referred to collectively as wireless stations 110 and individually as wireless station 110). MEC network 130 may include local MEC clusters 135 and a MEC orchestrator 140. Core network 150 may include network devices 155, and external network 160 may include network devices 165. Environment 100 further includes one or more UE devices 180 (referred to individually as ‘UE device 180’). Access network 105, MEC network 130, and core network 150 may be referred to collectively as a transport network.

The number, type, and arrangement of network devices and the number of UE devices 180 in environment 100 are exemplary. A network device, a network element, or a network function (referred to herein simply as a network device) may be implemented according to one or multiple network architectures, such as a client device, a server device, a peer device, a proxy device, a cloud device, a virtualized function, and/or another type of network architecture (e.g., Software Defined Networking (SDN), virtual, logical, and/or network slicing). Additionally, a network device may be implemented according to various computing architectures, such as centralized, distributed, cloud (e.g., elastic, public, and/or private), edge, fog, and/or another type of computing architecture.

Environment 100 includes communication links between the networks, between the network devices, and between UE devices 180 and the network devices. Environment 100 may be implemented to include wired, optical, and/or wireless communication links among the network devices and the networks illustrated. A connection via a communication link may be direct or indirect. For example, an indirect connection may involve an intermediary device and/or an intermediary network not illustrated in FIG. 1. A direct connection may not involve an intermediary device and/or an intermediary network. The number and the arrangement of communication links illustrated in environment 100 are exemplary.

Access network 105 may include one or multiple networks of one or multiple types and technologies. For example, access network 105 may include a Fifth Generation (5G) Radio Access Network (RAN), a Fourth Generation (4G) RAN, a 4.5G RAN, and/or another type of future generation RAN. By way of further example, access network 105 may be implemented to include a Next Generation (NG) RAN, an Evolved UMTS Terrestrial Radio Access Network (E-UTRAN) of a Long Term Evolution (LTE) network, an LTE-Advanced (LTE-A) network, and/or an LTE-A Pro network, and/or another type of RAN (e.g., a legacy RAN). Access network 105 may further include other types of wireless networks, such as a WiFi network, a Worldwide Interoperability for Microwave Access (WiMAX) network, a local area network (LAN), or another type of network that may provide an on-ramp to wireless stations 110 and/or core network 150.

Depending on the implementation, access network 105 may include one or multiple types of wireless stations 110. For example, wireless station 110 may include a next generation Node B (gNB), an evolved Node B (eNB), an evolved Long Term Evolution (eLTE) eNB, a radio network controller (RNC), a remote radio head (RRH), a baseband unit (BBU), a small cell node (e.g., a picocell device, a femtocell device, a microcell device, a home eNB, and/or a repeater), or another type of wireless node. According to an implementation, wireless stations 110 may include a gNB with multiple distributed components, such as a central unit (CU), a distributed unit (DU), a remote unit (RU or a remote radio unit (RRU)), or another type of distributed arrangement. Wireless stations 110 may connect to core network 150 and/or MEC network 130 via links 120 (e.g., backhaul links). Links 120 may include wired, optical, or wireless links. According to various embodiments, access network 105 may be implemented according to various architectures of wireless service, such as, for example, macrocell, microcell, femtocell, or other configuration. Additionally, according to various exemplary embodiments, access network 105 may be implemented according to various wireless technologies (e.g., radio access technology (RAT)), wireless standards, wireless frequencies/bands, and so forth.

MEC network 130 includes a platform that provides services at the edge of a network, such as access network 105. MEC network 130 may be implemented using one or multiple technologies including, for example, network function virtualization (NFV), software defined networking (SDN), cloud computing, or another type of network technology. Depending on the implementation, MEC network 130 may include, for example, virtualized network functions (VNFs), multi-access (MA) applications/services, and/or servers. MEC network 130 may also include other network devices that support its operation, such as, for example, a network function virtualization orchestrator (NFVO), a virtualized infrastructure manager (VIM), an operations support system (OSS), a local DNS, a virtual network function manager (VNFM), and/or other types of network devices and/or network resources (e.g., storage devices and/or communication links).

Local MEC clusters 135 may provide application services for use by UE devices 180. Local MEC clusters 135 may include various types of network devices that may be deployed in different areas/regions of MEC network 130. Each local MEC cluster 135 may include a platform that provides an application service. Local MEC clusters 135 may include virtual network devices (e.g., virtualized network functions (VNFs), servers, hosts, containers, hypervisors, virtual machines, network function virtualization infrastructure (NFVI), and/or other types of virtualization elements, layers, hardware resources, operating systems, and/or engines) and associated application services for use by UE devices 180. Local MEC clusters 135 may be located to provide geographic proximity to various groups of wireless stations 110. In some instances, local MEC clusters 135 may be co-located with wireless stations 110 or network devices 155. Alternatively, local MEC cluster 135 may not be co-located.

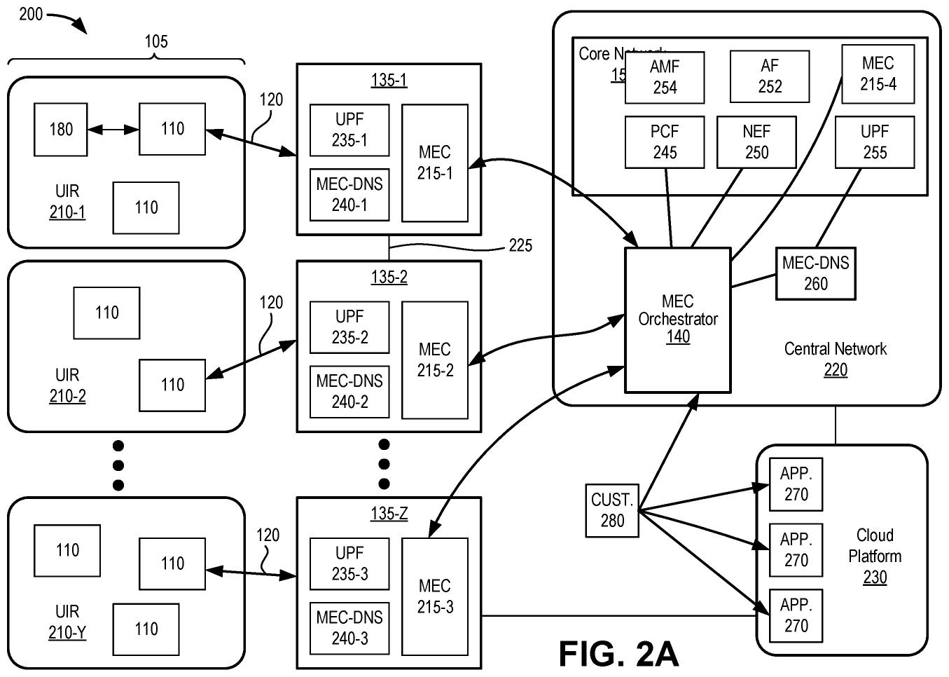

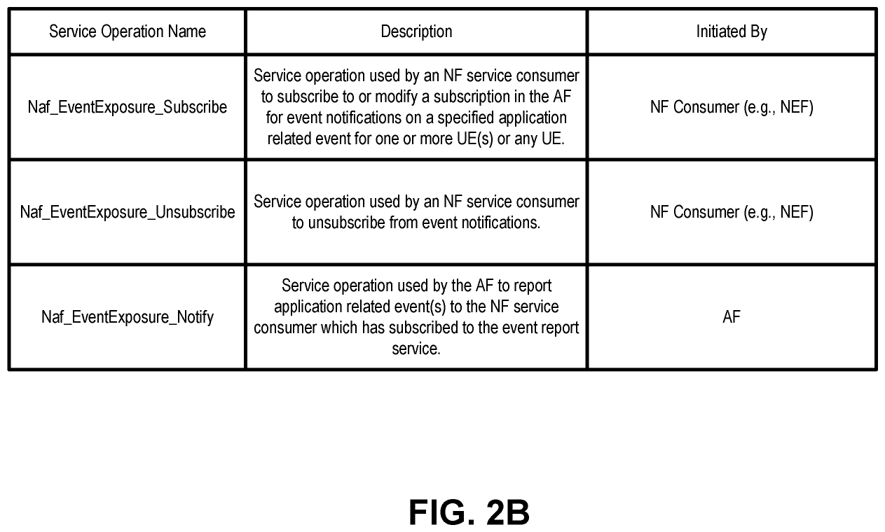

MEC orchestrator 140 may include logic that provides selection (of a local MEC cluster 135) and orchestration among local MEC clusters 135. According to one implementation, MEC orchestrator 140 may be a centralized component of MEC network 130. For example, MEC orchestrator 140 may be co-located with one or more network devices 155 of core network 150. MEC orchestrator 140 may maintain an overlay grid over an entire geographic coverage area. In one embodiment, the grid may divide the geographic coverage area into uniquely identifiable regions (UIRs). According to one implementation, MEC orchestrator 140 may track the KPIs, SLAs, and/or parameters that are used to define a customer's MEC application policy for each UIR or group of UIRs. Accordingly, a customer may define different application policies for different geographic regions. MEC orchestrator 140 is described further below in connection with, for example, FIG. 2A.

Core network 150 may include one or multiple networks of one or multiple network types and technologies. For example, core network 150 may be implemented to include a next generation core (NGC) network for a 5G network, an Evolved Packet Core (EPC) of an LTE network, an LTE-A network, an LTE-A Pro network, and/or a legacy core network. Depending on the implementation, core network 150 may include various network devices 155 to provide, for example, a user plane function (UPF), an access and mobility management function (AMF), a session management function (SMF), a unified data management (UDM) device, an authentication server function (AUSF), a network slice selection function (NSSF), a network repository function (NRF), a network exposure function (NEF), an application function (AF), and/or a policy control function (PCF). According to other exemplary implementations, core network 150 may include additional, different, and/or fewer network devices than those described. For purposes of illustration and description, network devices 155 may include various types of network devices that may be resident in core network 150, as described herein.

External network 160 may include one or multiple networks. For example, external network 160 may be implemented to include a service or an application-layer network, the Internet, an Internet Protocol Multimedia Subsystem (IMS) network, a Rich Communication Service (RCS) network, a cloud network, a packet-switched network, or other type of network that hosts an end device application or service. For example, the end device application/service network may provide applications or services pertaining to broadband access in dense areas (e.g., pervasive video, smart office, operator cloud services, and/or video/photo sharing), broadband access everywhere (e.g., 50/100 M bps, ultra low-cost network, etc.), higher user mobility (e.g., high speed train, remote computing, moving hot spots, etc.), Internet of Things (IoTs) (e.g., smart wearables, sensors, mobile video surveillance, etc.), extreme real-time communications (e.g., tactile Internet, etc.), lifeline communications (e.g., natural disaster, etc.), ultra-reliable communications (e.g., automated traffic control and driving, collaborative robots, health-related services (e.g., monitoring, remote surgery, etc.), drone delivery, public safety, etc.), and/or broadcast-like services.

Depending on the implementation, external network 160 may include various network devices 165. For example, external devices 165 may include applications, services, or other type of end device assets, such as servers (e.g., web, application, cloud, etc.), mass storage devices, data center devices, and/or other types of network devices pertaining to various network-related functions.

UE device 180 includes a device that has computational and/or wireless communication capabilities. UE device 180 may be implemented as a mobile device, a portable device, a stationary device, a device operated by a user, or a device not operated by a user. For example, UE device 180 may be implemented as a Mobile Broadband device, a smartphone, a computer, a tablet computer, a netbook, a wearable device, a vehicle support system, a game system, a drone, or some other type of wireless device. In some embodiments, UE device 180 may be configured to execute various types of software (e.g., applications, programs, etc.), such as an application client for an application that receives service from MEC network 130, external network 160, access network 105, and/or core network 150. UE device 180 may support one or multiple radio access technologies (RATs, e.g., 4G and/or 5G), one or multiple frequency bands, network slicing, and/or dual-connectivity. Additionally, UE device 180 may include one or multiple communication interfaces that provide one or multiple (e.g., simultaneous or non-simultaneous) connections via the same or different RATs, and/or frequency bands.

FIG. 2A is a diagram of exemplary network connections in a network portion 200 of environment 100. As shown in FIG. 2A, network portion 200 may include multiple unique identifiable regions (UIRs) 210-1 through 210-Y (referred to collectively as UIRs 210 and individually as UIR 210), each containing one or more wireless stations 110. Network portion 200 may also include MEC clusters 135-1 through 135-Z (referred to collectively as MEC clusters 135 and generally as MEC cluster 135), a central network 220, a cloud platform 230, and a customer device 280.

Each UIR 210 may be associated with a geographic area serviced by one or more wireless stations 110. For example, a UIR 210 may include a metropolitan area, a city, a geographic area associated with a postal zip code, etc. The geographic area of a UIR 210 may be defined, for example, based on the coverage of the particular wireless stations 110 (or cells) associated with the UIR. The geographic area of UIR 210 may include more than one non-contiguous areas. Accordingly, in one embodiment, multiple wireless stations 110 may be assigned to a UIR 210 (e.g., a single or only one UIR 210) and each wireless station 110 (or wireless station sector) may be assigned to a UIR 210 (e.g., a single or only one UIR 210). According to other implementations, a UIR 210 may correspond to a tracking area (TA) or a local area data network (LADN) service area.

MEC cluster 135 may service requests from UE devices 180 connected to wireless stations 110. Each MEC cluster 135 may include a UPF 235, an MEC DNS 240, and an MEC instance 215. Each MEC cluster 135 may be connected within MEC network 130 by transport links 225. Each MEC cluster 135 may be coupled to one or more wireless station 110 (e.g., via links 120) and coupled to core network 150 and/or other MEC clusters 135 via links 120. In some instances, a MEC cluster 135 may be located in or geographically near one of UIRs 210.

MEC instance 215 may include a combination of hardware and software to provide application services. MEC instance 215 may include, for example, devices that support the virtualization of CPU and/or GPU services. MEC instance 215 may include various physical resources (e.g., processors, memory, storage, and/or communication interface), software resources (e.g., operating system) and other virtualization elements (e.g., hypervisor and/or container engine). In the arrangement of network portion 200, the transport link 225 between any two MEC clusters 135 is optimized and the latency between any two MEC clusters is minimized. The MEC instances 215 in connected MEC clusters 135 may subscribe with each other and MEC orchestrator 140 to share information of local resource use, forecasts, and availabilities.

MEC cluster 135 and/or MEC instance 215 may be implemented in one or more cloud platforms, such as Amazon Web Services (AWS), Microsoft Azure, Google Cloud Platform, and/or IBM IOT Bluemix. For simplicity, in some implementations discussed below, each MEC cluster 135 may include one corresponding MEC instance 215 and each MEC instance 215 may include one corresponding MEC cluster 135.

UPF 235 may perform core network-type functions at a local MEC cluster 135. UPF 235 may maintain an anchor point for intra/inter-RAT mobility, maintain an external Packet Data Network (PDN) point of interconnection to a data network (e.g., cloud platform 230), perform packet routing and forwarding, perform the user plane part of policy rule enforcement, perform packet inspection, perform traffic use reporting, enforce QoS policies in the user plane, perform uplink traffic verification, perform transport level packet marking, perform downlink packet buffering, send and forward an “end marker” to a Radio Access Network (RAN) node (e.g., wireless station 110), and/or perform other types of user plane processes. UPF 235 may communicate with devices in core network 150 (e.g., an SMF, NEF 250, and/or UPF 255) and external network 160.

DNS 240 may provide domain name services (e.g., local DNS services) for MEC cluster 135. DNS 240 may include logic that provides DNS resolution services for application services and/or microservices provided by MEC network 130. DNS 240 may serve, for example, a particular UIR 210 to update addresses associated with FQDNs for particular services instantiated at a local MEC instance 215. DNS 240 may receive updates from, or provide updates to, an upstream domain name server, such as authoritative DNS 260 (e.g., in a central part of MEC network 130).

Central network 220 may include a provider network that includes or is in communication with core network 150. Central network 220 may include one or more devices included in MEC network 130, such as MEC orchestrator 140 and authoritative DNS 260. As mentioned above, core network 150 may include, among other network functions, PCF 245, NEF 250, and core UPF 255.

MEC orchestrator 140 may track KPIs and parameters that are used in a customer's MEC application policy. Using an overlay grid, MEC orchestrator 140 may divide a geographic coverage area into UIRs that are matched to a customer's designated coverage area for MEC services (e.g., a particular city, borough, and/or district). The customer's designated coverage area may include multiple UIRs 210 (referred to as “target UIRs”). MEC orchestrator 140 may maintain an updated list of wireless stations 110 (or cell sites) serving the UIRs 210; an updated list of core network devices 155 (e.g., UPF 235 and/or UPF 255) serving the UIRs 210; and/or an updated list of MEC clusters 135 connected to the core infrastructure. MEC orchestrator 140 may use network data to identify a MEC cluster 135 that can support a customer's application policy.

Some examples of KPIs/parameters tracked by MEC orchestrator 140 include: (1) min, max, and/or average round trip time over-the-air from the cell-site to the boundaries of the UIRs, (2) min, max, and/or average round trip time from cell-site to the UPF serving the UIR, (3) min, max, and/or average round trip time from the cell-site serving the UIR to the UPF and MEC location(s), (4) resource availability of the MEC cluster, (5) backhaul availability on the MEC network, and (6) details of application instances running on the MEC clusters.

After MEC orchestrator 140 assigns a MEC cluster 135 for an application, MEC orchestrator 140 may receive dynamic resource updates from network functions in access network 105, MEC network 130, and core network 150 to dynamically manage MEC resource queries for UE device 180. In relation to MEC selection and orchestration processes, core network 150 may include, among other network functions, a PCF 245, a NEF 250, AF 252, AMF 254, and a core UPF 255.

PCF 245 may support policies to control network behavior, provide policy rules to control plane functions (e.g., to an SMF (not shown)), access subscription information relevant to policy decisions, execute policy decisions, and/or perform other types of processes associated with policy enforcement. PCF 245 may specify QoS policies based on QoS flow identity (QFI) consistent with 5G network standards.

AF 252 may provide services associated with a particular application, such as, for example, an application for influencing traffic routing, an application for accessing NEF 260, an application for interacting with a policy framework for policy control, and/or other types of applications. AF 252 may be accessible via an Naf interface, for example.

AMF 254 may perform registration management, connection management, reachability management, mobility management, lawful intercepts, session management messages transport between UE device 180 and SMF, access authentication and authorization, location services management, functionality to support non-3GPP access networks, and/or other types of management processes. AMF 254 may be accessible by other function nodes via an Namf interface.

NEF 250 may expose/advertise capabilities, events, and status of network functions (NFs) to other NFs. NFs may include, for example, third party NFs, edge computing NFs (e.g., MEC clusters 135) and/or other types of NFs. For example, NEF 250 may secure provisioning of information from external applications to core network 150, translate information between core network 150 and devices/networks external to core network 150, support a Packet Flow Description (PFD) function, and/or perform other types of network exposure functions. In one embodiment, NEF 250 may use a standard API framework to send and/or receive messages to/from NRF 258, MEC orchestrator 140, AF 252, and other devices in environment 100.

Core UPF 255 may enable service continuity for inter-MEC mobility events. UPF 255 may perform functions at a central level (e.g., from central network 220), similar to functions described for UPF 235 above.

NRF 258 may support a service discovery function and maintain profiles of available network function (NF) devices/instances and their supported services. An NF profile may include an NF instance identifier (ID), an NF type, a Public Land Mobile Network (PLMN) ID associated with the NF, network slice IDs associated with the NF, capacity information for the NF, service authorization information for the NF, supported services associated with the NF, endpoint information for each supported service associated with the NF, and/or other types of NF information. Additionally, NRF 258 may include one or more transport network key performance indicators (KPIs) associated with the NF device/instance. NRF 258 may be accessible via an Nnrf interface 259. In one embodiment, NRF 258 may use a standard API framework to send and/or receive messages to/from NEF 250, MEC orchestrator 140, AF 252, and other devices in environment 100.

Authoritative DNS 260 may provide centralized DNS services for MEC network 130. Authoritative DNS 260 may include logic that provides DNS resolution services for application services and/or micro-services provided by MEC network 130. In some implementations, authoritative DNS 260 and MEC orchestrator 140 may be combined in a single device or group of devices.

Cloud platform 230 may correspond to external network 160. Different cloud platforms 230 may use different protocols and commands. Examples of cloud platform 230 may include AWS, Microsoft Azure, Google Cloud Platform, and/or IBM IOT Bluemix. According to an implementation, cloud platform 230 may host different application services 270 used by UE devices 180. Application services 270 may, for example, work in conjunction with MEC instances 215 to provide application services to UE devices 180. According to an implementation described herein, application services 270 may identify when UE devices 180 enters a UIR 210 with available MEC services.

Customer device 280 may include a mobile device or a stationary computing device that is capable of communicating with other devices in network environment 100. In one implementation, customer device 280 may provide an interface to obtain a software development kit (SDK) and configurations for application programming interfaces (APIs) for use in developing applications that can use service from cloud platform 230 and/or MEC clusters 135. According to an implementation, customer device 280 may be used to select parameters (e.g., configuration files) for a MEC application policy where different geographic areas may receive different levels of MEC service.

FIG. 2B is an example of service operations that may be used in interactions between an application function (e.g., AF 252) and a network exposure function (e.g., NEF 250) of FIG. 2A. Service operation names include Naf_EventExposure_Subscribe, Naf_EventExposure_Unsubscribe, and Naf_EventExposure_Notify. These service operations are exemplary. Additional, fewer, or different operations are possible.

The service operation named ‘Naf_EventExposure_Subscribe’ allows for an NF service consumer to subscribe to or modify a subscription in the AF for event notifications on a specified application related event for one or more UE(s) or any UE. For example, NEF 250 may subscribe to application information (such as FQDNs) from AF 252.

The service operation named ‘Naf_EventExposure_Unsubscribe’ may be used by an NF service consumer to unsubscribe from event notifications. For example, NEF 250 may unsubscribe to application information (such as FQDNs) from AF 252.

The service operation named ‘Naf_EventExposure_Notify’ may be used by the AF to report application related event(s) to the NF service consumer which has subscribed to the event report service. For example, AF 252 may send notification messages to NEF 250 with information related to applications (such as FQDNs).

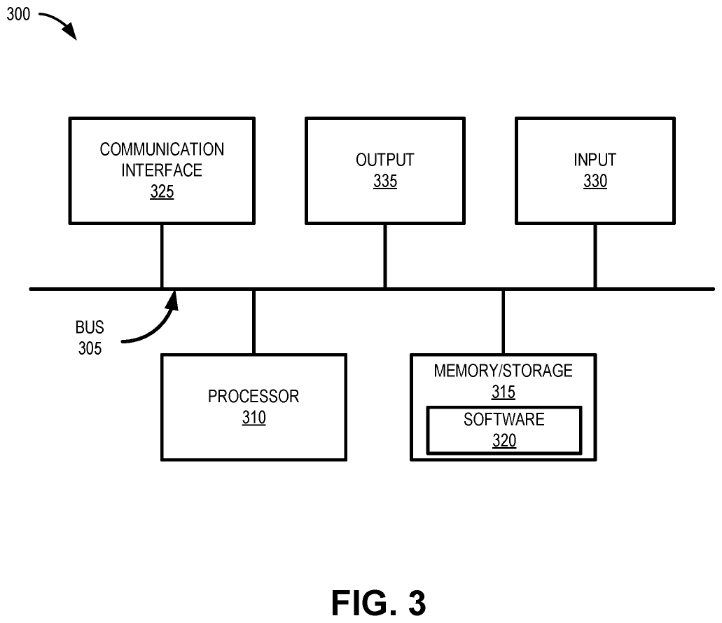

FIG. 3 is a diagram illustrating example components of a device 300 (e.g., a computing device) according to an implementation described herein. Wireless station 110, MEC orchestrator 140, network device 155, network device 165, UE device 180, MEC instance 215, UPF 235, DNS 240, PCR 245, NEF 250, UPF 255, and/or cloud application service 270 may each include or be instantiated on one or more devices 300. In another implementation, a device 300 may include multiple network functions. As illustrated in FIG. 3, according to an exemplary embodiment, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, and/or clocks.

Processor 310 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 310 may be implemented as hardware (e.g., a microprocessor), a combination of hardware and software (e.g., a SoC, and/or an ASIC), may include one or multiple memories (e.g., cache, etc.), etc. Processor 310 may be a dedicated component or a non-dedicated component (e.g., a shared resource).

Processor 310 may control the overall operation, or a portion of operation(s), performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, etc.

Memory/storage 315 includes one or multiple memories and/or one or multiple other types of storage mediums. For example, memory/storage 315 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Memory/storage 315 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 315 may include a drive for reading from and writing to the storage medium.

Memory/storage 315 may be external to and/or removable from device 300, such as, for example, a Universal Serial Bus (USB) memory stick, a dongle, a hard disk, mass storage, off-line storage, network attached storage (NAS), or some other type of storing medium (e.g., a compact disk (CD), a digital versatile disk (DVD), a Blu-Ray disk (BD), etc.). Memory/storage 315 may store data, software, and/or instructions related to the operation of device 300.

Software 320 includes an application or a program that provides a function and/or a process. Software 320 may include an operating system. Software 320 is also intended to include firmware, middleware, microcode, hardware description language (HDL), and/or other forms of instruction. Additionally, for example, MEC cluster 135 and/or MEC orchestrator 450 may include logic to perform tasks, as described herein, based on software 320. Furthermore, UE devices 180 may store applications that require services/resources from MEC clusters 135.

Communication interface 325 permits device 300 to communicate with other devices, networks, systems, devices, and/or the like. Communication interface 325 includes one or multiple wireless interfaces and/or wired interfaces. For example, communication interface 325 may include one or multiple transmitters and receivers, or transceivers. Communication interface 325 may include one or more antennas. For example, communication interface 325 may include an array of antennas. Communication interface 325 may operate according to a communication standard and/or protocols. Communication interface 325 may include various processing logic or circuitry (e.g., multiplexing/demultiplexing, filtering, amplifying, converting, error correction, etc.).

Input 330 permits an input into device 300. For example, input 330 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 335 permits an output from device 300. For example, output 335 may include a speaker, a display, a light, an output port, and/or some other type of visual, auditory, tactile, etc., output component. According to some embodiments, input 330 and/or output 335 may be a device that is attachable to and removable from device 300.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a process described herein. Alternatively, for example, according to other implementations, device 300 performs a process described herein based on the execution of hardware (processor 310, etc.). Links 120

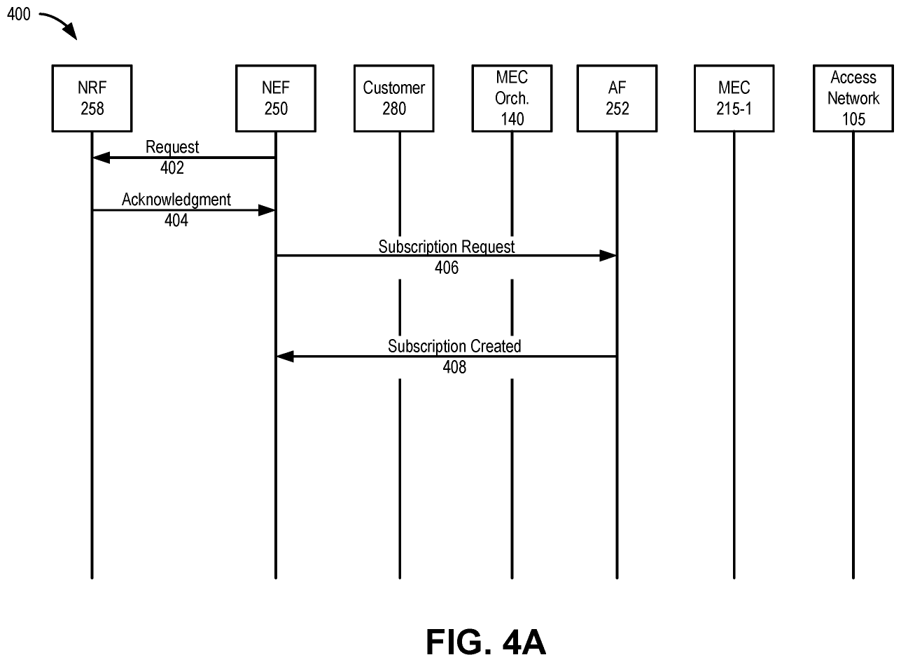

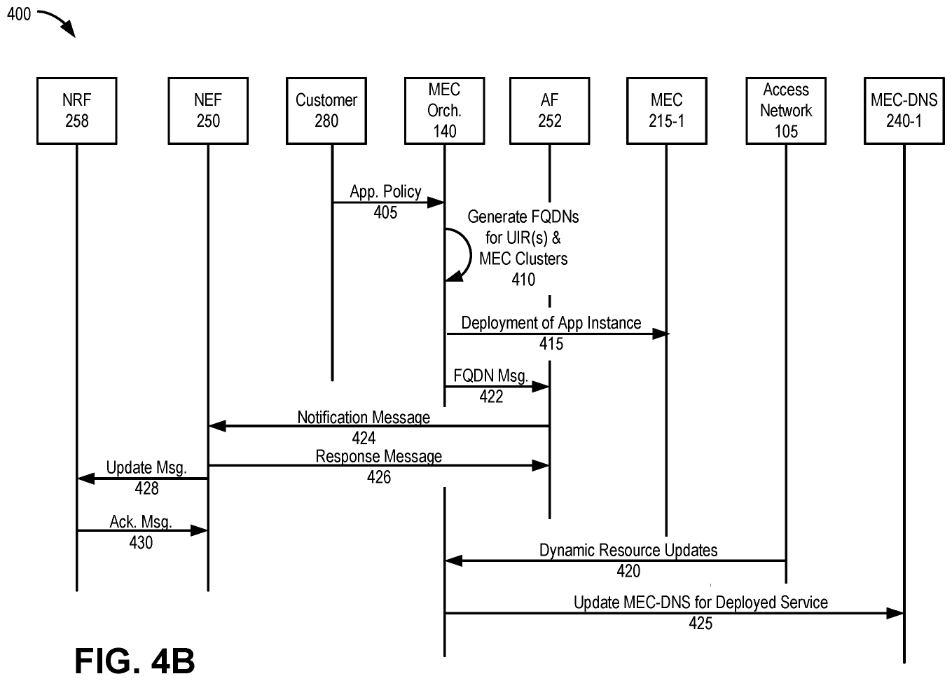

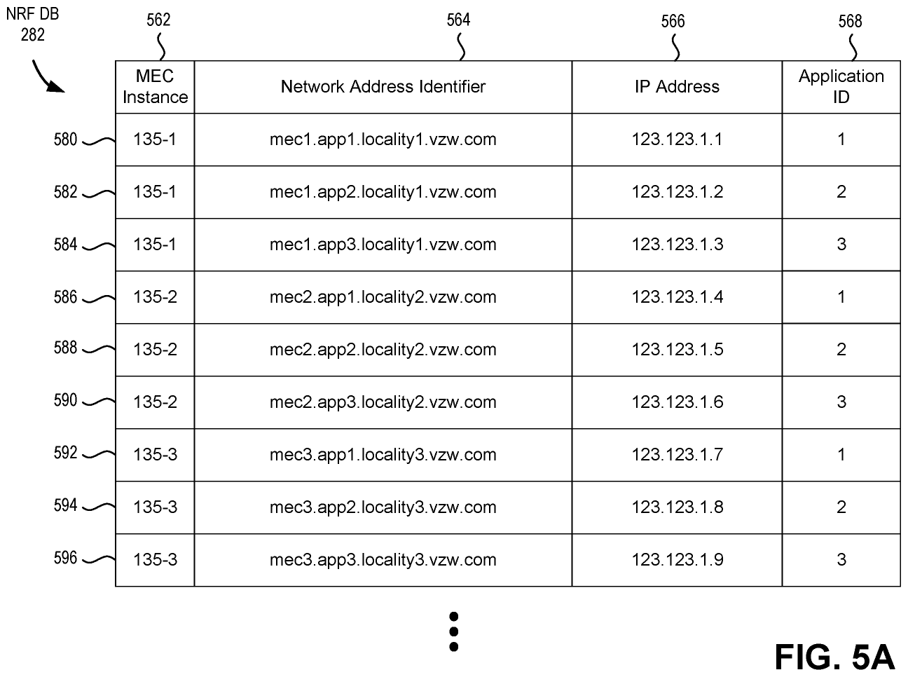

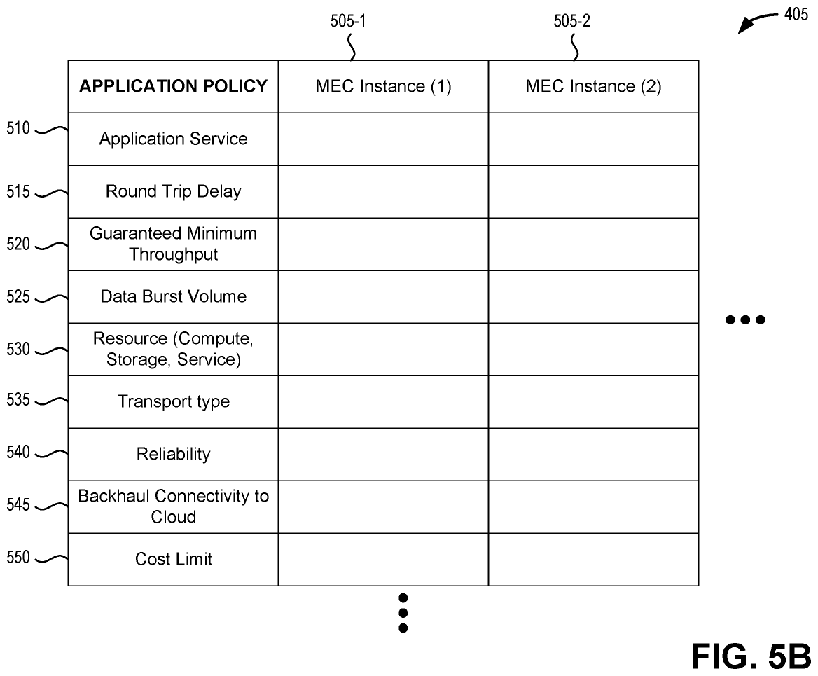

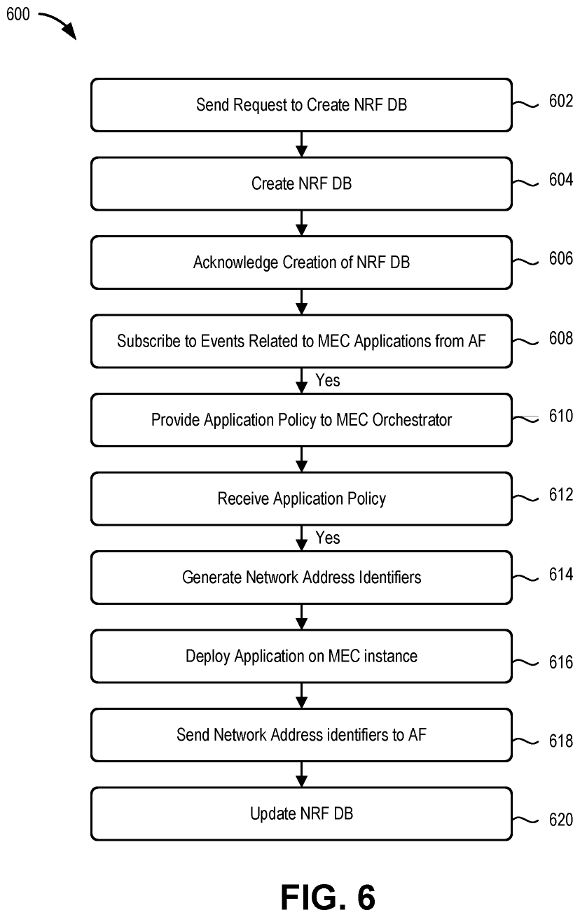

FIGS. 4A and 4B are diagrams of exemplary communications for configuring MEC resources for traffic routing and dynamic edge discovery in a portion 400 of network environment 100. Network portion 400 may include customer device 280, MEC orchestrator 140, MEC-DNS 240-1, access network 105 (with wireless station 110), and MEC instance 215-1 and 215-2 of MEC network 130. FIG. 4A is described in conjunction with FIGS. 5A, 5B, and 6. FIGS. 5A and 5B provide examples of fields that may be included in NRF DB 282 and in application policy 405, respectively. FIG. 6 is a flowchart of a process 600 for registering MEC-enabled applications that reside in UE device 180.

In the example described below, a customer at customer device 280 wishes to launch a new MEC application on a MEC platform, such as that shown in network portion 200 and/or network portion 400. Process 600 may be implemented as software instructions stored in memory 315 that are executed by processor 310 (e.g., by one or more of the devices described herein). Process 600 may begin with NEF 250 creating a NRF DB 282 in NRF 258. NEF 250 may send a request 402 for registration with NRF 258 (block 602) (e.g., with a PUT command) for the purpose of creating and maintaining NRF DB 282. The registration from NEF 250 to NRF 258 may include an identifier to identify an associated NF profile (i.e., “NFProfile”).

FIG. 5A provides an example of fields that may be included in NRF DB 282. As shown in FIG. 5A, each record in NRF DB 282 may include a MEC platform field 562, an network address identifier field 564, an IP address field 566, and/or an application ID field 568. NRF DB 282 includes nine records (e.g., record 580 through record 596). These fields are exemplary and NRF DB 282 may include additional or fewer fields or a different arrangement of fields.

MEC instance field 562 may include an identity of one or more MEC platforms, instances, and/or clusters (e.g., MEC platform 1, MEC platform 2, etc). As shown in MEC DB 282 in FIG. 5A, MEC instance field 562 specifies ‘135-1’ for MEC cluster 135-1 (e.g., records 580-584), ‘135-2’ for MEC cluster 135-2 (e.g., records 586-590), and ‘135-3’ for MEC cluster 135-3 (e.g., records 592-596) MEC instance field 562 may specify any number of MEC clusters (e.g., more than 3).

Network address identifier field 564 may include a network address identifier or identifiers (e.g., FQDNs) associated with applications running on the corresponding MEC platform identified in field 562 and/or associated with an application identified in application ID field 568. As shown in NRF DB 282 in FIG. 5A, Network address identifier field 564 includes mec1.app1.locality1.vzw.com (record 580) and mec3.app3.locality3.vzw.com (record 596).

IP address field 566 may include the IP address (e.g., IPv4 and/or IPv6) associated with the FQDN stored in network address identifier field 564. Application ID 568 may store the identity of the application that corresponds to the information in corresponding network address identifier field 564 and IP address field 566. As shown in NRF DB 282 in FIG. 5A, IP address field 566 includes IPv4 addresses such as 123.123.1.1.

Returning to FIG. 4, once NRF 258 creates NRF DB 282 (block 604), NRF 258 may send an acknowledgment 404 to the request for registration with a confirmation 404 (block 606) (e.g., a “201 Created” as shown in FIG. 4). NEF 250 may subscribe to events related to new applications from AF 252 (block 608). To do so, NEF 250 may send a subscription request message 406 to AF 252 for subscribing to events related to new applications. In one embodiment, NEF 250 uses the standard API (e.g., Naf_EventExposure_Subscribe service operation) to create the new subscription towards AF to subscribe for new application information. AF 252 may respond with a subscription created message 408 (e.g., “201 Created” message) that a subscription to the information has been created.

Thus, in this embodiment, NEF 250 creates NRF DB 282 (block 604) and a subscription relationship (block 608) with AF 252 regarding application information (such as when customer device 280 wishes to deploy an application in environment 100). With NRF DB 282 and the subscription relationship, NEF 250 may update NRF DB 282 with FQDNs when appropriate. In one embodiment, when customer device 280 wishes to deploy a new application (e.g., a MEC application) on any of the MEC cluster 135, AF 252 and/or NEF 250 may use a standard API framework to register the application with core network 150 (e.g., the 5GC system) by exposing the FQDN associated with the application via AF 252 and NEF 250 with NRF 258. NRF 258 may build application profiles (e.g., MEC application profiles) for use by core network 150 for dynamic edge discovery for MEC-enabled devices.

As shown in FIG. 4B, when a customer wishes to deploy an application in environment 100, customer device 280 may provide to MEC orchestrator 140 an application policy 405 for MEC services (block 610). Application policy 405 may be provided, for example, as a configuration file and may define the parameters for selection of an MEC cluster 135 or set of MEC clusters 135 for an application. Application policy 405 may identify a requested coverage area and service parameters for that area. Customer device 280 may provide different service parameters for different coverage areas. For example, a developer may choose a higher level of MEC services for a city or borough over other areas (or vice versa).

FIG. 5B provides an example of fields that may be included in application policy 405. As shown in FIG. 5B, application policy 405 may include one or more MEC instance fields 505 (e.g., 505-1, 505-2, etc.), an application service field 510, a round trip delay field 515, a guaranteed minimum throughput field 520, a data burst volume field 525, a resource field 530, a transport type field 535, a reliability level field 540, a backhaul connectivity type field 545, and a cost level field 550.

MEC instance field 505 may include information identifying a city, a group of cities, a region, one or more postal zip codes, or another geographic area (e.g., a longitude/latitude, or range thereof). Entries in MEC instance field 505 may define an area to which other fields in application policy 405 will apply. According to an implementation, application policy 405 may include multiple coverage areas with different policy configurations. According to an implementation, entries in MEC instance field 505 may be converted/matched to a corresponding group of UIRs 210.

Application service field 510 may identify a type of service category that will be applied to the application service. Examples of an application service include video live, video buffered, uplink streaming, voice, critical signaling, best effort, GBR, delay critical GBR, and non-GBR service.

Round trip delay field 515 may include information identifying a maximum round-trip time or another latency value that may be associated with signals for the application. Entries for round trip delay field 515 may be supplied, for example, as numerical values (e.g., in milliseconds) or a selection from defined time ranges. Guaranteed minimum throughput field 520 may identify a minimum downlink throughput (e.g., in Mbps). Entries for minimum throughput field 520 may be supplied, for example, as numerical values (e.g., in Mbps) or selected from defined size ranges.

Data burst volume field 525 may include a maximum data burst volume or a similar flow control parameter. Data burst volume field 525 may denote the largest amount of data that the MEC network is required to serve.

Resource field 530 may include information identifying a MEC resource type used by the application. Resource types may include, for example, compute, storage or service. Transport type field 535 may identify a requested type of transport link between MEC cluster 135 and access network 105, such as IPSec, point-to-point, etc.

Reliability level field 540 may indicate a reliability level, such as about 99.9% or 99.99% packet delivery. In another implementation, reliability level field 540 may indicate a corresponding descriptor (e.g., good, better, best, etc.) that corresponds to a required reliability metric. Backhaul connectivity type field 545 may indicate connectivity requirements from MEC instance 215 to a cloud application service 270 in cloud platform 230, such as direct connectivity or indirect connectivity.

Cost level field 550 may include information indicating a cost threshold associated with a service. For example, a developer may select from low, medium, or high cost options to indicate a customer's cost appetite. A selected cost option in cost level field 550 may be used, for example, to set a priority between conflicting MEC resource requests.

Returning to FIG. 4B, MEC orchestrator 140 may receive application policy 405 (e.g., from customer device 280) (block 612). In response, as indicated at reference 410, MEC orchestrator 140 may create, determine, and/or derive network addresses identifiers (e.g., domain names, FQDNs, and/or network addresses) that correspond to UIRs 210, MEC instance 215, and/or MEC cluster 135 (block 614). The FQDNs may be based on information in application policy 405 (e.g., from MEC instance field 505). In one embodiment, MEC orchestrator 140 may generate an FQDN for each MEC cluster 135, MEC instance 215, and/or each UIR 210. For example, for a given application (e.g., app1), deployed on a first MEC instance (e.g., mec1) at a particular locality (e.g., locality1), the generated FQDN may be: mec1.app1.locality1.vzw.com. For the same application at a second MEC instance (e.g., mec2) at a different locality (e.g., locality2), the generated FQDN may be: mec2.app1.locality2.vzw.com. In addition, MEC orchestrator 140 may check the requested service parameters against advertised resources on access network 105, MEC network 130, and core network 150. In one embodiment, MEC orchestrator 140.

MEC orchestrator 140 may deploy an application on a MEC instance by sending deployment 415 of an application service instance at the identified MEC clusters 135 (block 616). For example, assuming MEC orchestrator 140 identifies that MEC cluster 135-1 can support the parameters of application policy 405 for the requested area, MEC orchestrator 140 may provide instructions to MEC cluster 135 to deploy an application service instance. In addition, MEC orchestrator 140 may also send a message 422 including the network address identifier or network address (e.g., FQDN or FQDNs) to AF 252 (block 618). In one embodiment, MEC orchestrator 140 uses a standard API framework to send the application FQDN to AF 252. Upon receipt of the FQDN, AF 252 sends notification message 424 to NEF 250 because NEF 250 has subscribed to new application information, such as new FQDNs. In response, NEF 250 sends a notification response message 426 to AF 252.

NEF 250 may send an update message 428 of the NF profile including the network address identifier (e.g., FQDN or FQDNs) corresponding to the new MEC application. NRF 258 may update its NRF DB 282 accordingly (block 620). To continue the example from above, the FQDN mec1.app1.locality1.vzw.com may be added to NRF DB 282 (as shown in record 580 of FIG. 5A); and the FQDN mec2.app1.locality2.vzw.com may be added to NRF DB 282 (as shown in record 586 of FIG. 5A). Once an application is deployed, MEC orchestrator 140 may utilize cellular network intelligence parameters to maintain a dynamic view of network environment 100. For example, MEC orchestrator 140 may receive dynamic resource updates 420 from devices in access network 105 that are within the target UIRs 210. Information in dynamic resource updates 420 may include, for example: (1) average capacity utilization of radio resources in a UIR 210; (2) UPFs 235 serving a given UIR 210; (3) minimum/maximum round trip time (RU) over the air from a wireless station 110 to the edge of the UIRs 210; (4) minimum/maximum/average RU from a wireless station 110 to a UPF 255 in core network 150 that is serving a UIR 210; (5) minimum/maximum/average RU from a wireless station 110 serving a UIR 210 to a local UPF 235 and MEC instance 215 in MEC cluster 135; (6) resource availability on the MEC cluster 135 serving the UIR 210; (7) backhaul availability on the MEC cluster 135 serving the UIR 210; and/or (8) details of application instances running on MEC cluster 135.

MEC orchestrator 140 may use dynamic resource updates 420 to both evaluate network performance against service level agreements (SLAs) and manage service assignments for application service requests from UE devices 180. For example, based on dynamic resource updates 420, MEC orchestrator 140 may provide a DNS update 425 to each applicable MEC-DNS 240 (e.g., MEC-DNS 240-1) with information about local MEC instances 215 that will support a network address or network address identifier (e.g., an FQDN) associated with an application. According to one embodiment, MEC-DNS 240 may be updated with: (1) resolution records for a FQDN (e.g., an IP address), which may be different for each UIR 210; (2) UPF 235 identifiers serving a given UIR 210; and (3) Fifth Generation QoS Identifier (5QI) bearer details or another bearer-type indicator (e.g., QCI-1, QCI-2, etc., with each corresponding to a type of service), which can be provided to an end device to properly implement a requested application service.

Thus, in addition to an IP address from a traditional DNS lookup, MEC-DNS 240 may also also configured to provide other network information necessary to ensure a UE device 180 receives MEC services that efficiently support an application policy (e.g., a UPF identifier and the type of bearer to set up for the service).

Network portion 400 may include additional, fewer, or a different arrangement of components. Further, communications shown in FIGS. 4A and 4B provide simplified illustrations of communications in network portion 400 and are not intended to reflect every signal or communication exchanged between devices/functions. For FIGS. 4A and 4B, it is assumed that a geographic area that provides MEC services is divided into a set of UIRs 210, MEC instances 215, and/or MEC clusters 135.

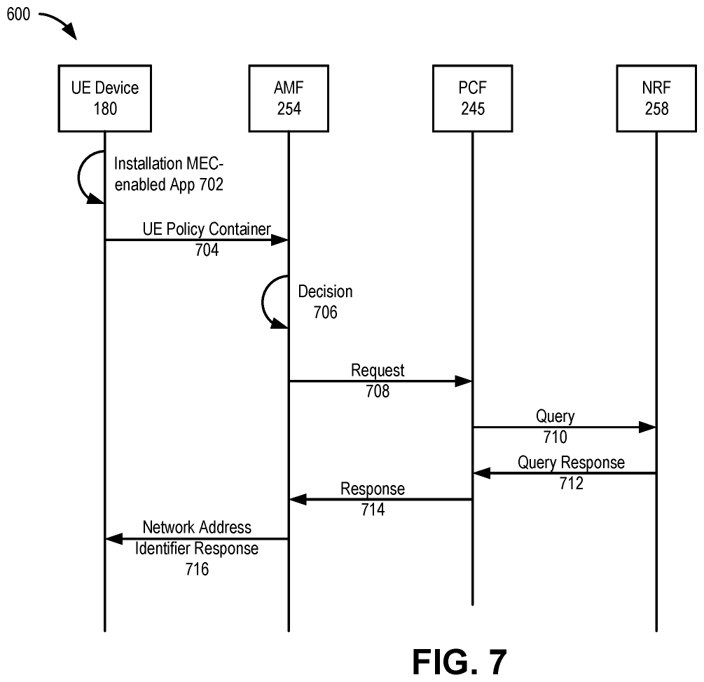

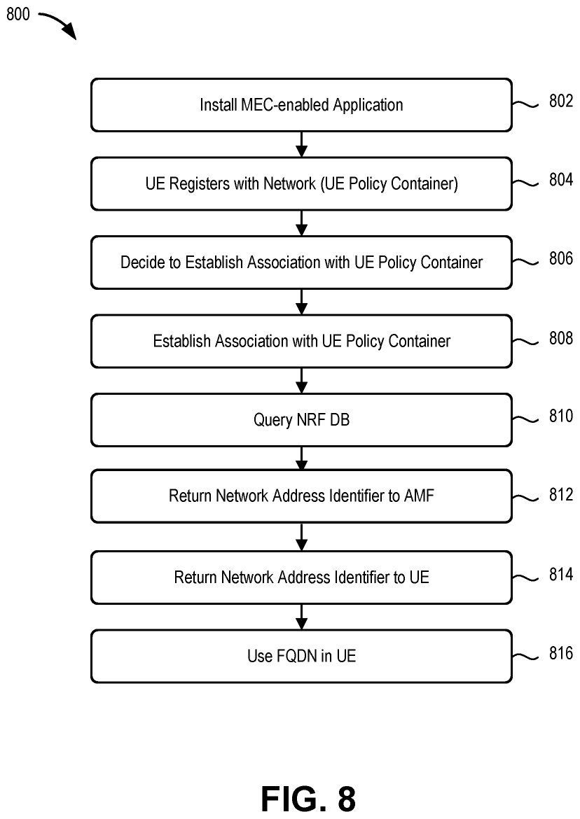

FIG. 7 is a diagram of exemplary communications for configuring MEC resources for traffic routing and dynamic edge discovery in a portion 700 of network environment 100. FIG. 7 is described with respect to FIG. 8, which is a flowchart of an exemplary process 800 for an MEC-enabled application to register and receive an FQDN. Process 800 may be implemented as software instructions stored in memory 315 that are executed by processor 310 (e.g., by one or more of the devices described herein).

Network portion 700 may include UE device 180, AMF 254, PCF 245, and/or NRF 258. For FIG. 7, it is assumed that a geographic area that provides MEC services is divided into a set of UIRs 210, MEC instances 215, and/or MEC clusters 135. UE device 180 may have a MEC-enabled application 702 installed. For example, the user of UE device 180 may visit Google's Play Store, Apple's App Store, and/or Amazon's Application store to download and install an application that is MEC enabled (e.g., if UE device 180 is a mobile telephone and/or tablet computer) (block 802). Upon executing the MEC-enabled application, UE device 180 may register with network portion 200. When registering, UE device 180 may send a UE policy container 704 to AMF 254 (block 804). UE policy container 704 may include one or more parameters such as: the MEC application ID and/or an associated FQDN for registration. In this example, the FQDN for registration may be an FQDN that is different from those stored in NRF DB 282. UE policy container 704 may also include the location of UE device 180, an identification of the MEC data network name (DNN) and/or slice. The location of UE device 180 may include global coordinates (e.g., latitude and/or longitude) or other information to determine location (such as fixed-location hardware addresses).

AMF 254 may decide to establish an association 706 with UE policy container 704 received from UE device 180 (block 806). If an association is to be established (block 806), then AMF 254 may send a request 708 to create a policy association to PCF 245 (block 808). In response to policy association request 708, PCF 245 may send a query 710 to NRF 258 (block 810). Query 710 may include the MEC application ID and/or the FQDN specified in a UE route selection policy (URSP) in the UE policy container. NRF 258 may select the appropriate FQDN and respond with (in a query response 712) with the FQDN associated with the MEC application ID and/or specified FQDN. In one embodiment, the FQDN selected may be based on the application (e.g., application ID and/or FQDN) and/or the location of UE device 180. For example, a MEC-enabled application running in UE device 180 may specify ‘app1’ in ‘locality1’. NRF 258 may, based on this information, query NRF DB 282 and respond with the following FQDN: app1.mec1.locality1.vzw.com. PCF 245 may in turn respond (in response 714) to AMF 254 with the associated network address identifier (e.g., FQDN) (block 812). Further, AMF 254 may respond to UE device 180 with a response 716 including the network address identifier (e.g., FQDN) (block 814). As a result, UE device 180 may use the FQDN to address the appropriate MEC instance 215 and/or MEC cluster 135 (block 816) (e.g., through a DNS query).

Communications shown in FIG. 7 provide simplified illustrations of communications in network portion 700 and are not intended to reflect every signal or communication exchanged between devices/functions. In one embodiment, NEF 250 may also unsubscribe to events related to new applications from AF 252. To do so, NEF 250 may send an unsubscribe request message to AF 252 for unsubscribing to events related to new applications. In one embodiment, NEF 250 uses the standard API (e.g., Naf_EventExposure_Unsubscribe service operation) to remove an existing subscription towards AF to unsubscribe for new application information. AF 252 may respond with a subscription removed message that a subscription to the information has been removed.

As set forth in this description and illustrated by the drawings, reference is made to “an exemplary embodiment,” “an embodiment,” and/or “embodiments,” which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks or signals have been described with regard to the processes illustrated in FIGS. 4A, 4B, 6, 7, and 8 the order of the blocks or signals may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known to those of ordinary skill in the art are expressly incorporated herein by reference and are intended to be encompassed by the claims.

1. A device, comprising:
a receiver, to receive application parameters for an application to be serviced using multi-access edge computing (MEC) resources;
a processor, to generate domain names based on the application parameters;
a memory to store the domain names associated with the application to be serviced using the MEC resources; and
a transmitter,
wherein the processor is further configured to deploy an instance of the application at a MEC cluster, and wherein the instance of the application that is deployed is accessible by user equipment (UE) with one of the domain names,
wherein the receiver is configured to receive, from a UE device, a parameter associated with a MEC-enabled application running in the UE device and associated with the application to be serviced using MEC resources, and
wherein the transmitter is configured to send, to the UE device, the one of the domain names in response to and based on the parameter associated with the MEC-enabled application.

2. The device of claim 1,
wherein the parameter associated with the MEC-enabled application includes an identity of the application to be serviced using MEC resources; and
wherein the transmitter is configured to send, to the UE device, the one of the domain names based on the identity of the application to be serviced using MEC resources.

3. The device of claim 2, wherein the transmitter is configured to:
send, to the UE device, the one of the domain names based on a location of the UE device.

4. The device of claim 1, wherein the MEC resources includes a plurality of MEC instances, and wherein generating the domain names associated with the application based on the application parameters includes generating the domain names based on identities of the plurality of MEC instances.

5. The device of claim 1, wherein the processor is configured, when generating the domain names associated with the application based on the application parameters, to generate the domain names based on an application service level agreement (SLA).

6. The device of claim 1, wherein the MEC resources includes a plurality of MEC instances, and wherein the processor is configured, when generating the domain names associated with the application based on the application parameters, to generate the domain names based on a location of the MEC instance.

7. The device of claim 1, wherein the domain names include fully-qualified domain names (FQDNs), and wherein the processor is further configured to update a MEC-domain name service (DNS) for the deployed instance of the application at the MEC cluster with the FQDNs.

8. The device of claim 7, wherein the processor is further configured to update the MEC-DNS by sending to the MEC-DNS a resolution record for a fully qualified domain name (FQDN) associated with the deployed instance of the application.

9. The device of claim 8,
wherein the receiver is configured to receive a DNS query for the application, wherein the DNS query includes the FQDN.

10. A method, comprising:
receiving, by a network device, application parameters for an application to be serviced using multi-access edge computing (MEC) resources;
generating, by the network device, domain names associated with the application based on the application parameters;
storing, by the network device in a memory, a database of the domain names associated with the application to be serviced using the MEC resources;
deploying, by the network device, an instance of the application at a MEC cluster, wherein the deployed instance of the application is accessible by user equipment with one of the domain names;
receiving, from a user equipment (UE) device, a parameter associated with a MEC-enabled application running in the UE device and associated with the application to be serviced using MEC resources, and
sending, to the UE device, the one of the domain names in response to and based on the parameter associated with the MEC-enabled application.

11. The method of claim 10, wherein the parameter associated with the MEC-enabled application includes an identity of the application to be serviced using MEC resources, the method further comprising:
and
sending, by the network device to the UE device, one of the domain names based on the identity of the application to be serviced using MEC resources.

12. The method of claim 11, further comprising sending, to the UE device, the one of the domain names based on a location of the UE device.

13. The method of claim 10, wherein the MEC resources includes a plurality of MEC instances, and wherein generating the domain names associated with the application based on the application parameters includes generating the domain names based on identities of the plurality of MEC instances.

14. The method of claim 10, wherein generating the domain names associated with the application based on the application parameters includes generating the domain names based on an application service level agreement (SLA).

15. The method of claim 10, wherein the MEC resources includes a plurality of MEC instances, and wherein generating the domain names associated with the application based on the application parameters includes generating the domain names based on a location of the MEC instance.

16. The method of claim 10, wherein the domain names include fully-qualified domain names (FQDNs), the method further comprising:
updating, by the network device, a MEC-domain name service (DNS) for the deployed instance of the application at the MEC cluster with the FQDNs.

17. The method of claim 16, wherein updating the MEC-DNS further comprises sending to the MEC-DNS a resolution record for a fully qualified domain name (FQDN) associated with the deployed instance of the application.

18. A non-transitory, computer-readable storage media storing instructions executable by one or more processors, the instructions comprising:
receiving application parameters for an application to be serviced using multi-access edge computing (MEC) resources;
generating domain names associated with the application based on the application parameters;
storing, in a memory, the domain names associated with the application to be serviced using the MEC resources; and
deploying an instance of the application at a MEC duster, wherein the deployed instance of the application is accessible by user equipment with one of the domain names;
receiving, from a user equipment (UE) device, a parameter associated with a MEC-enabled application running in the UE device, wherein the MEC-enabled application running in the UE device is associated with the application to be serviced using MEC resources; and
sending, to the UE device, one of the domain names based on the parameter associated with the MEC-enabled application.

19. The non-transitory, computer-readable storage media of claim 18, wherein the parameter associated with the MEC-enabled application includes an identity of the application to be serviced using MEC resources, the instructions further comprising:
sending, to the UE device, one of the one of the domain names based on the identity of the application to be serviced using MEC resources.

20. The non-transitory, computer-readable storage media of claim 18,
wherein the MEC resources includes a plurality of MEC instances, and wherein generating the domain names associated with the application based on the application parameters includes generating the domain names based on identities of the plurality of MEC instances; or
wherein generating the domain names associated with the application based on the application parameters includes generating the domain names based on an application service level agreement (SLA); or
wherein the MEC resources includes a plurality of MEC instances, and wherein generating the domain names associated with the application based on the application parameters includes generating the domain names based on a location of the MEC instance.
